(19) United States
(12) Patent Application Publication
(10) Pub. No.: US 2014/0370147 A1
(43) Pub. Date: Dec. 18, 2014

(54) PACKAGE FOR CONSUMABLE PRODUCTS AND METHODS FOR USING SAME

(71) Applicants: Stephane Hentzel, Yvonand (CH); Barry Longson, Chardonne (CH); Marc Montarras, Pully (CH)

(72) Inventors: Stephane Hentzel, Yvonand (CH); Barry Longson, Chardonne (CH); Marc Montarras, Pully (CH)

(21) Appl. No.: 14/363,802

(22) PCT Filed: Jan. 11, 2013
(86) PCT No.: PCT/IB2013/050251

§ 371 Date: Jun. 8, 2014

(30) Foreign Application Priority Data
Jan. 11, 2012 (US) 61586204

(51) Int. Cl. A45F 3/20; A23L 1/29

(52) U.S. Cl. CPC A45F 3/20; A23L 1/296
USPC 426/2; 426/115; 222/96

(57) ABSTRACT

Packages (10) for housing consumable products and methods of using same are provided. The packages (10) may be customized, functional packages that are designed to prevent accidental spillage or leakage of a flowable consumable product housed therein. In a general embodiment, flexible packages (10) are provided and include a body (12) defining a cavity (14) for housing a flowable 12 product and a channel (16) for dispensing the flowable product from the cavity, wherein the channel (16) has a length that is from about two to about four times a width of the channel. In another embodiment, the channel (16) comprises a length-to-width ratio that is sufficient to prevent a liquid from leaking from the flexible package (10) without a force applied to the flexible package.

### BACKGROUND

The present disclosure relates generally to packaging. More specifically, the present disclosure relates to containers for storing consumable products and methods of using same.

Packages for consumable products come in a variety of sizes, shapes, materials and designs. These sizes, shapes, materials and designs generally differ, for example, for aesthetic reasons or for reasons related to the products the packaging is intended to house. For example, a flexible package designed to house a solid, consumable bar product would not likely be sufficient to house a sterile gel product. As such, consumable product packaging should be designed for a specific functionality and/or a specific food product that the packaging is intended to house.

### SUMMARY

The present disclosure is related to packages for housing consumable products. The packages may be customized, functional packages that are designed to prevent accidental spillage or leakage of a flowable consumable product housed therein. In a general embodiment, flexible packages are provided. The flexible packages include a body defining a cavity for housing a flowable product and a channel for dispensing the flowable product from the cavity, wherein the channel has a length that is from about 2 to about 4 times a width of the channel.

In another embodiment, flexible packages are provided. The flexible packages include a body defining a cavity for housing a liquid product and a channel for dispensing the liquid product from the cavity, wherein the channel has a length-to-width ratio that is sufficient to prevent a liquid from leaking from the flexible package absent a sufficient force applied to the flexible package.

In an embodiment, a length of the channel is from about 2 to about 4 times the width of the channel. Alternatively, a length of the channel may be from about 2.5 to about 3 times the width of the channel.

In an embodiment, the length of the channel is from about 12 mm to about 40 mm, or from about 14 mm to about 38 mm, or from about 16 mm to about 36 mm, or from about 18 mm to about 34 mm, or from about 20 mm to about 32 mm, or from about 22 mm to about 30 mm, or from about 24 mm to about 28 mm.

In an embodiment, the width of the channel is from about 6 mm to about 10 mm, or from about 7 mm to about 9 mm, or about 8 mm.

In an embodiment, the channel is centered along a width of the flexible package. The length of the channel may be about 3 times the width of the channel.

In an embodiment, the channel is off-centered along a width of the flexible package. The length of the channel is about 2.5 times the width of the channel.

In an embodiment, the channel has a shape selected from the group consisting of square, rectangular, cylindrical, or combinations thereof.

In an embodiment, the flexible package further includes a sealed portion at an end of the channel. The sealed portion may have a width from about 3 to about 7 mm, or from about 4 to about 6 mm, or about 5 mm.

In an embodiment, the body has a shape selected from the group consisting of a square, circle, triangle, pentagon, hexagon, heptagon, octagon, nonagon, decagon, hendecagon, dodecagon, or combinations thereof.

In an embodiment, the flexible package is a pouch.

In an embodiment, the body includes at least two composite layers sealed together. The at least two composite layers may be heat-sealed together.

In yet another embodiment, methods for administering a flowable consumable product to a consumer in need of same are provided. The methods include providing a flexible package having a body defining a cavity for housing a flowable product and a channel for dispensing the flowable product from the cavity, wherein the channel has a length that is from about 2 to about 4 times a width of the channel. The methods further include instructing a consumer to apply a force to the flexible package to administer the flowable product to the consumer.

In still yet another embodiment, methods for administering a flowable consumable product to a consumer in need of same are provided. The methods include providing a flexible package having a body defining a cavity for housing a liquid product and a channel for dispensing the liquid product from the cavity, wherein the channel has a length-to-width ratio that is sufficient to prevent a liquid from leaking from the flexible package absent a sufficient force applied to the flexible package, and instructing a consumer to apply a force to the flexible package to administer the flowable product to the consumer.

In an embodiment, the force is selected from the group consisting of pressing on the flexible package, shaking the flexible package, or combinations thereof.

In an embodiment, the length of the channel is from about 2 to about 4 times the width of the channel, or about 2.5 or 3 times the width of the channel.

In an embodiment, the length of the channel is from about 12 mm to about 40 mm, or from about 14 mm to about 38 mm, or from about 16 mm to about 36 mm, or from about 18 mm to about 34 mm, or from about 20 mm to about 32 mm, or from about 22 mm to about 30 mm, or from about 24 mm to about 28 mm.

In an embodiment, the width of the channel is from about 6 mm to about 10 mm, or from about 7 mm to about 9 mm, or about 8 mm.

In an embodiment, the channel is centered along a width of the flexible package. The length of the channel may be about 3 times the width of the channel.

In an embodiment, the channel is off-centered along a width of the flexible package. The length of the channel is about 2.5 times the width of the channel.

In an embodiment, the channel has a shape selected from the group consisting of square, rectangular, cylindrical, or combinations thereof.

In an embodiment, the flexible package further includes a sealed portion at an end of the channel. The sealed portion may have a width from about 3 to about 7 mm, from about 4 to about 6 mm, or about 5 mm.

In an embodiment, the body has a shape selected from the group consisting of a square, circle, triangle, pentagon, hexagon, heptagon, octagon, nonagon, decagon, hendecagon, dodecagon, or combinations thereof.

In an embodiment, the flexible package is a pouch.

In an embodiment, the body includes at least two composite layers sealed together. The at least two composite layers may be heat-sealed together.

It is an advantage of the present disclosure to provide improved consumable product containers.

It is also an advantage of the present disclosure to provide consumable product containers that prevent accidental spillage or leakage of flowable contents in the container.

It is another advantage of the present disclosure to provide consumable product containers that optimize dimensions of the containers for specific uses.

It is a further advantage of the present disclosure to provide consumable product containers that are easily handled by consumers for consumption during physical activity.

Additional features and advantages are described herein, and will be apparent from the following Detailed Description and the figure.

### BRIEF DESCRIPTION OF THE FIGURES

FIG. 1 illustrates a flexible consumable product container in accordance with an embodiment of the present disclosure.

### DETAILED DESCRIPTION

Definitions

As used herein, the term “capillary forces” is preferably understood to include the ability of a liquid to flow in narrow spaces without the assistance of, and in opposition to external forces like gravity (http://en.wikipedia.org/wiki/Capillary_action).

The present disclosure provides packages for housing consumable products. The packages may be custom designed for ease of use by consumers (e.g., athletes) before, during or after physical activity. For example, during vigorous physical activity, athletes desire to maintain appropriate levels of specific nutrients such as carbohydrates and electrolytes for improved or sustained athletic performance or increased mental alertness. It is known to provide such nutrition in, for example, performance bars. Although the performance bars provide individuals with adequate nutrition for prolonged or endurance performance, the individual may not enjoy consuming these types of performance bars. In this regard, the performance compositions may be difficult to consume during exercise or may be too dense or heavy for consumption before or during exercise, or may have a chalky or bland taste.

Alternatively, it is also known to provide adequate nutrition for prolonged or endurance performance in the form of gels. Such gels are typically found in flexible, pouch-like packaging and may be easily consumed by the athlete during performance of vigorous activity. In this regard, the only action required by the athlete is to either (i) press the flexible pouch to force the gel into the athlete's mouth, or (ii) to tip the gel package upside down so that gravity will allow the gel product to flow from the package naturally. If the package tips, however, the viscosity of the gel product and the shape of most packages will prohibit most of the gel product from flowing from the package. Thus, a gel package may be provided with a short distribution channel adapted to retain the gel in the package upon accidental spillage. If a less viscous, more liquid-like product were included in the package, however, simply tipping the package over would likely result in the loss of a large amount, if not all, of the product contained within the package.

The packages of the present disclosure provide flexible pouch-like packages that prevent accidental spillage of a low viscosity, or liquid product after opening of the packages. The consumable products housed by the packages may be any flowable consumable products including, for example, liquids, semi-solids, gels, etc. In an embodiment, the consumable product is a liquid product. The teachings of the present disclosure, however, are not limited to liquid products and may include any products capable of flowing. The skilled artisan will appreciate that the viscosity of the product contained in the present packages or containers may be determined, at least in part, by temperature. For example, a substance at a high temperature may be less viscous, while the same substance at a low temperature may be more viscous.

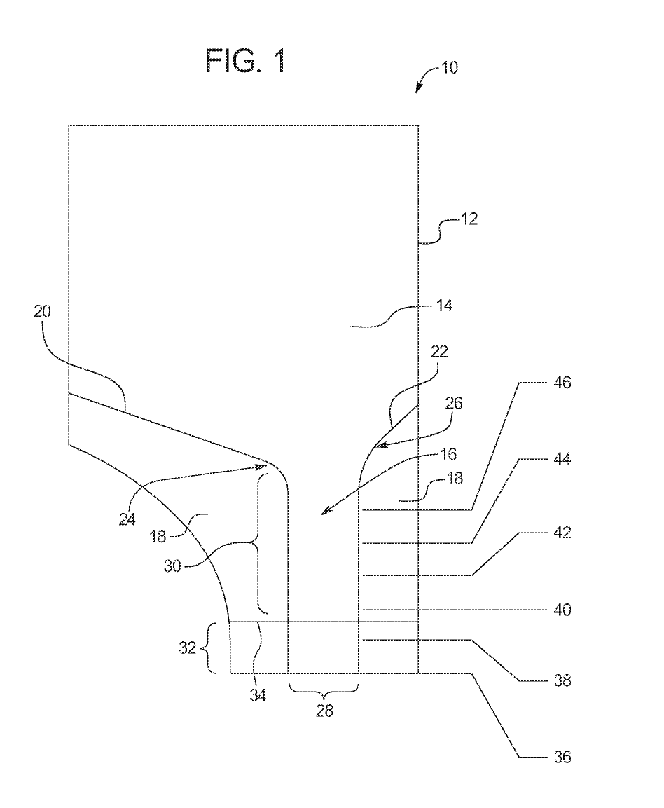

In an embodiment, and as shown in FIG. 1, a package 10 for storing consumable products is provided. Package 10 includes a body 12 that defines a shape. The shape and size of body 12 is not critical and body 12 may have any size or shape known the skilled artisan. For example, body 12 may be a square, circle, triangle, pentagon, hexagon, heptagon, octagon, nonagon, decagon, hendecagon, dodecagon, or three-dimensional versions of any of the previously listed shapes, or combinations thereof. Body 12 is also not limited to a specific size, so long as body 12 is capable of housing a flowable consumable product.

Body 12 may be made from materials that are sealable and flexible such as, for example, flexible plastic films. In an embodiment, body 12 is a flexible pouch, which provides several advantages over rigid containers. For example, the shape of a flexible pouch adapts to available space, pouches are lighter in weight than rigid containers, when emptied of the contents, pouches require less space, when filled with contents, the thickness dimension is small, permitting faster processing times and mitigating heat damage to foods, they are not subject to corrosion or breakage, and they are easier to open by athletes during vigorous physical activity.

Body 12 may also be a flexible, composite package. In an embodiment, body 12 is a sealable, flexible, composite package having from about two to about four, or about three layers of substrates. The substrates may include, for example, a flexible plastic film, an impermeable layer, or combinations thereof. In an embodiment, body 12 includes an outer polymer layer that is resistant to wear and tear, an inner polymer layer that is resistant to wear and tear and seals well, and a middle aluminum foil layer for eliminating light from the contents as well as for making the pouch material impermeable to gases. The layers may be bonded together with an adhesive. In an embodiment, body 12 includes (i) a layer of polyethylene terephthalate that is from about 10 to about 15 μm thick, or about 12 μm thick, (ii) a layer of aluminum foil that is from about 5 μm to about 10 μm thick, or about 7 μm thick, and (iii) a layer of polyethylene that is from about 60 μm to about 80 μm, or about 70 μm thick. In an embodiment, body 12 is formed from two layers (i.e., single or composite) comprising flexible plastic films that are sealed together.

Body 12 is so constructed and arranged to house a flowable, consumable product in a cavity 14 that includes a channel 16 for dispensing a flowable, consumable product from cavity 14. The shape of cavity 14 and channel 16 are defined, at least in part, by a sealed portion 18 of body 12. Sealed portion 18 is formed from a top layer and a bottom layer (i.e., single or composite layers) comprising flexible plastic films that are sealed together to form body 12. In other words, the shape and size of cavity 14 and channel 16 are determined by the portions of the top layer and the bottom layer that are not sealed together.

In an embodiment, and as shown in FIG. 1, cavity 14 has a substantially square shape that is formed from sealed portions 18. As is also shown in FIG. 1, cavity 14 includes a side having a first slope 20 and a second slope 22 leading up to channel 16. Providing slopes 20, 22 helps a flowable, consumable product housed in cavity 14 to flow smoothly from cavity 14 toward and into channel 16 to be dispensed from package 10. Since first slope 20 has a much longer length than second slope 22 (i.e., channel 16 is offset from a center of package 10 such that channel 16 is closer to second slope 22 than first slope 20), second slope 22 has in increased slope to help the flowable, consumable product on that side of package 10 flow from cavity 14 into channel 16.

Further, the embodiment illustrated in FIG. 1 shows a first shoulder 24 and a second shoulder 26 where first slope 20 and second slope 22 meet channel 16, respectively. As is clearly illustrated in the figure, first shoulder 24 is at a lower height than second shoulder 26 with respect to a length of package 10. In other words, first shoulder 24 is not at the same horizontal position as second shoulder 26 with respect to a length of package 10. Applicant believes, without being bound to any theory, that providing first slope 20, second slope 22, first shoulder 24, and second shoulder 26 as configured in FIG. 1 helps to provide improved dispensing of a flowable, consumable product from package 10 without accidental spillage of the product. Applicant also believes, however, that it may be possible to provide package 10 with a centered channel 16, although measurements for the channel may be slightly different than measurements for the channel 16 as illustrated, which will be discussed further below.

The dimensions of channel 16 become important once the flowable, consumable product housed in cavity 14 begins to flow into channel 16. Without being bound to any theory, Applicant believes that the specific dimensions of channel 16 are able to dispense a flowable, consumable product upon application of a force (e.g., shaking, or pressing) to package 10, without allowing accidental spillage or leakage of the flowable, consumable product after package 10 is opened. Indeed, Applicant has found that a width 28 of channel 16 should be within a certain range, as well as a ratio of a length 30 to width 28 of channel 16.

With respect to width 28 of channel 16, Applicant has surprisingly found that width 28 should be within a range from about 6 mm to about 10 mm, or from about 7 mm to about 9 mm, or about 8 mm. Width 28 may be constant along length 30 of channel 16, or may vary along length 30. In an embodiment, width 28 is constant along length 30 of channel. Once flow begins through channel 16, channel 16 becomes a three-dimensional structure having a radius (not illustrated). Having a constant radius is important since unwanted folds can simply stop the flow of the product through channel 16.

Regarding length 30 of channel 16, Applicant has surprisingly found that length 30 should be about two to about four times width 28, or about two-and-a-half or three times width 28. For example, length 30 of channel 16 may range from about 12 mm to about 40 mm, or about 14 mm to about 38 mm, or about 16 mm to about 36 mm, or about 18 mm to about 34 mm, or about 20 mm to about 32 mm, or about 22 mm to about 30 mm, or about 24 mm to about 28 mm, or about 18, 20, 22, 24, 26 or 28 mm. When length 30 is within the specified dimensions, Applicant has found that the top and bottom layers of body 12 forming channel 16 stick together and a significant or deliberate amount of force must be applied to package 10 to empty the contents of package 10. Through various experiments performed by Applicant, it is believed that the top and bottom layers of body 12 forming channel 16 stick together due to capillary forces. Additionally, the amount of force that must be applied to package 10 to empty the contents of package 10 should be a deliberate force such as squeezing or shaking that is sufficient to overcome the capillary forces that stick the layers of body 12 together.

Applicant has performed many experiments to determine the optimal length of channel 16 for preventing accidental spill and/or leakage when provided with a predetermined width of channel 16. For example, and as shown by FIG. 1, the numerical indicators along the right side of package 10 indicate measurements along channel 16 starting at 36, which is a reference point of zero distance, and ending with 46. At a position in channel 16 corresponding to both of the 36 and 38 indicators, there can be no flow through channel 16 because of a sealed portion 32 of a specific width that seals package 10 closed. In an embodiment, sealed portion 32 may be a heat-sealed portion. Sealed portion 32 may have width (defined by the area 32 in FIG. 1) from about 3 to about 10 mm, or about 4 to about 8 mm, or about 5, 6 or 7 mm. By providing sealed portion 32 at a sufficient width, package 10 can better withstand common wear and tear that occurs during packaging, shipping and retail display. In this regard, a sufficient width of sealed portion 32 will ensure that package 10 cannot be accidentally torn open, thereby contaminating the consumable product.

In an embodiment, and between indicators 38 and 40 of FIG. 1, package 10 may be provided with a tear line 34 to assist a consumer in easily opening package 10 to release product from channel 16. Tear line 34 may be perforated or scored for easy tearing by the consumer, and may include a pre-torn portion at an edge of tear line 34 to aid in initiating a tear to remove sealed portion 32. When length 30 of channel 16 is at least as long as indicator 40, the flowable, consumable product housed in package 10 will not accidentally spill or leak from package 10. Alternatively, if length 30 of channel 16 is shorter than indicator 40, accidental spill or leakage may occur. For example, if length 30 of channel 16 were as long as indicator 42, leakage of the product (e.g., a slow flow) can occur with gentle shaking of package 10. If length 30 of channel 16 were as long as indicator 44, leakage of the product (e.g., a moderate flow) can occur even without shaking of package 10. Further, if length 30 of channel 16 were as long as indicator 46, leakage of the product (e.g., a continuous flow) can occur without application of any force to package 10. Accordingly, Applicant has surprisingly found that accidental spillage or leakage of a liquid consumable food product contained within package 10 having channel 16 may be prevented if the dimensions of package 10 are properly configured. In other words, a liquid consumable product will most likely not leak or spill from package 10 if length 30 of channel 16 is from about two to about four times width 28, or about two-and-a-half or three times width 28.

Additionally, indicators 36, 38, 40, 42, 44 and 46 of FIG. 1 may correspond to measurements along package 10. For example, and in an embodiment, indicator 36 may be a reference point at 0 mm. In an embodiment, indicator 38 may be about 2 to about 4, or about 3 mm from indicator 36. In an embodiment, indicator 40 may be about 5 to about 7, or about 6 mm from indicator 36. In an embodiment, indicator 42 may be about 8 to about 10, or about 9 mm from indicator 36. In an embodiment, indicator 44 may be about 11 to about 13, or about 12 mm from indicator 36. In an embodiment, indicator 46 may be about 14 to about 16, or about 15 mm from indicator 36.

As mentioned above, placement of channel 16 may slightly change dimensions of channel 16. For example, since channel 16 is off-center in FIG. 1, Applicant believes that there may be slightly more resistance to flow through channel 16 than if channel 16 were placed in the center of a side of package 10. Accordingly, a small change in dimensions may be necessary to optimize a length of channel 16. In this regard, when channel 16 is off-center, length 30 may best be determined as about two-and-a-half to up to about three times width 28, whereas when channel 16 is centered, length 30 may be best determined as about three times width 28. Further tests will be performed to determine the accuracy of length measurements depending on the placement of channel 16. However, the present application should not be limited by the disclosure set forth herein regarding same.

Additionally, a certain amount of force is required to be applied to the presently claimed packages in order to dispense a liquid contained in package 10. A sufficient amount of force may be provided by the consumer by pinching package 10 between the fingers of the consumer. Additionally, the force required may depend on the viscosity of the flowable consumable product contained within package 10, or the temperature of the package containing a flowable consumable product. In this regard, the flowable consumable product may be more liquid at warmer temperatures thereby requiring a lesser force to dispense the product. Alternatively, the flowable consumable product may be more gel-like at colder temperatures thereby requiring a greater force to dispense the product.

As an additional feature, package 10 may include indicia (not illustrated) provided on an exterior of body 12 for marketing purposes. The indicia may include, for example, logos, advertisements, branding information, nutritional information, product information, manufacturer information, etc. The indicia may be printed on a pressure sensitive material, printed directly on package 10, printed on a removable closure, etc.

In sum, the packages of the present disclosure provide improved construction so as to prevent accidental spillage or leakage of a liquid consumable product housed therein. Additionally, the presently disclosed shape of the packages provides a correct flow of product from a channel formed in the package, and the length of the channel also helps to close the channel with two fingers.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A flexible package comprising:
a body defining a cavity for housing a flowable product and a channel for dispensing the flowable product from the cavity, a sealed portion at an end of the channel configured to be removed for dispensing;
wherein the channel comprises a length-to-width ratio that is sufficient to prevent a liquid from leaking from the flexible package without a force applied to the flexible package; and
wherein in the absence of external pressure to the flexible package, the capillary forces of the flowable product occlude the channel from dispensing the flowable product from the cavity.

2. The flexible package according to claim 1, wherein the channel comprises a length that is from about 2 to about 4 times the width of the channel.

3. The flexible package according to claim 1, wherein the length of the channel is about 3 times the width of the channel.

4. The flexible package according to claim 1, wherein the length of the channel is from about 12 mm to about 40 mm.

5. The flexible package according to claim 1, wherein the length of the channel is from about 16 mm to about 36 mm.

6. The flexible package according to claim 1, wherein the length of the channel is from about 20 mm to about 32 mm.

7. The flexible package according to claim 1, wherein the length of the channel is from about 24 mm to about 28 mm.

8. The flexible package according to claim 1, wherein the width of the channel is from about 6 mm to about 10 mm.

9. The flexible package according to claim 1, wherein the width of the channel is from about 7 mm to about 9 mm.

10. The flexible package according to claim 1, wherein the sealed portion comprises a width from about 3 to about 7 mm.

11. The flexible package according to claim 1, wherein the channel is centered along a width of the flexible package.

12. The flexible package according to claim 1, wherein the channel is off-centered along a width of the flexible package.

13. The flexible package according to claim 1, wherein the flexible package is a pouch.

14. The flexible package according to claim 1, wherein the body comprises at least two composite layers sealed together.

15. The flexible package according to claim 1, wherein the body comprises at least two composite layers are heat-sealed together.

16. The flexible package according to claim 1, wherein the body comprises a shape selected from the group consisting of a square, circle, triangle, pentagon, hexagon, heptagon, octagon, nonagon, decagon, hendecagon, dodecagon, and combinations thereof.

17. The flexible package according to claim 1, wherein the channel comprises a shape selected from the group consisting of square, rectangular, cylindrical, and combinations thereof.

18. A method for administering a flowable consumable product to a consumer in need of same, the method comprising:
a flexible package selected from the group consisting of those claimed in claim 1 to claim 10;
instructing a consumer to remove the sealed portion; and
instructing a consumer to apply a force to the flexible package to administer the flowable product to the consumer.

19. The method according to claim 11, wherein the force is selected from the group consisting of pressing on the flexible package, shaking the flexible package, and combinations thereof.

20. The method according to claim 11, wherein the removing is selected from a group consisting of: tearing, cutting, twisting, unscrewing, breaking, and combinations thereof.
